(19) United States
(12) Patent Application Publication
(10) Pub. No.: US 2006/0046144 A1
(43) Pub. Date: Mar. 2, 2006

(54) Anode composition for lithium ion battery

(75) Inventor: Mark N. Obrovac, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/962,703

(22) Filed: Oct. 12, 2004

Related U.S. Application Data
(60) Provisional application No. 60/606,208, filed on Sep. 1, 2004.

(51) Int. Cl. H01M 4/40; H01M 4/04

(52) U.S. Cl. 429/231.95; 429/219; 429/220; 205/59

(57) ABSTRACT

Lithium ion batteries and methods of making lithium ion batteries are described. The lithium ion batteries have an anode that includes a silicon containing, alloy-type material. The alloy composition, which suppresses the formation of crystalline Li₁₅Si₄ during lithiation, contains (i) silicon, (ii) copper, and (iii) silver or a silver alloy.

### STATEMENT OF PRIORITY

This application claims priority to U.S. Provisional Patent Application No. 60/606208 filed on Sep. 1, 2004.

### BACKGROUND

Rechargeable lithium ion batteries are included in a variety of electronic devices. Most commercially available lithium ion batteries have anodes that contain materials such as graphite that are capable of incorporating lithium through an intercalation mechanism during charging. Such intercalation-type anodes generally exhibit good cycle life and coulombic efficiency. However, the amount of lithium that can be incorporated per unit mass of the graphite material is relatively low.

A second class of anode material is known that includes metals capable of incorporating lithium through an alloying mechanism during charging. Although these alloy-type anodes can often incorporate higher amounts of lithium per unit mass than intercalation-type anodes, at least some alloy-type anodes exhibit relatively poor cycle life and coulombic efficiency. The poor performance of these alloy-type anodes may result from the formation of a two-phase region during lithiation and delithiation. The two-phase region can lead to internal stress within the anode materials if one phase undergoes a larger volume change than the other phase. This internal stress can result in the disintegration of the anode material over time.

Further, some of the alloy-type anodes tend to undergo a relatively large volume change during lithiation and delithiation. This volume change can result in the deterioration of electrical contact between the active anode materials, conductive diluent (e.g., carbon) particles, and binder that form the anode. The deterioration of electrical contact, in turn, can result in diminished capacity (i.e., amount of lithium that can be incorporated per unit mass of the active anode material) over the cycle life of the anode.

### SUMMARY

Lithium ion batteries and methods of making lithium ion batteries are provided. The lithium ion batteries have an anode that contains an alloy-type material that includes silicon. The alloy composition suppresses the formation of crystalline Li₁₅Si₄ during lithiation, a material that may adversely affect the cycle life of alloy-type anodes that contain silicon.

In one aspect, a lithium ion battery is provided that includes a cathode, an anode that contains an alloy composition, and an electrolyte that separates the cathode from the anode. The alloy composition of the anode includes (i) silicon, (ii) copper, and (iii) silver or a silver alloy. More specifically, the alloy composition contains silicon in an amount of at least 10 mole percent, copper in an amount of at least 3 mole percent, and silver or a silver alloy in an amount of 1 to 50 mole percent based on moles of the alloy composition. The anode can be subjected to repetitive cycles of lithiation and delithiation. After 5 repetitive cycles of lithiation and delithiation to a potential less than 50 millivolts versus a Li/Li⁺ reference electrode during lithiation, no more than 15 percent of an area under a differential capacity versus voltage curve for the anode measured during delithiation results from a removal of lithium from a crystalline Li₁₅Si₄ phase.

In another aspect, a method of preparing a lithium ion battery is provided. The method includes providing a cathode, an anode, and an electrolyte that separates the cathode from the anode; and subjecting the anode to repetitive cycles of lithiation and delithiation to a potential less than 50 millivolts versus a Li/Li⁺ reference electrode during lithiation. The anode contains an alloy composition that includes silicon in an amount of at least 10 mole percent, copper in an amount of at least 3 mole percent, and silver or a silver alloy in an amount of 1 to 50 mole percent based on moles of the alloy composition. After 5 such repetitive cycles of lithiation and delithiation, no more than 15 percent of an area under a differential capacity versus voltage curve for the anode measured during delithiation results from a removal of lithium from a crystalline Li₁₅Si₄ phase.

The above summary is not intended to describe each disclosed embodiment or every implementation of the present invention. The detailed description section that follows more particularly exemplifies these embodiments.

### BRIEF DESCRIPTION OF THE DRAWINGS

The invention can be more completely understood in consideration of the following detailed description of various embodiments of the invention in connection with the accompanying drawings, in which:

FIG. 1 is plot of intensity versus scattering angle of the powder x-ray diffraction pattern of an alloy composition Si₅₂Cu₃₉Ag₉.

FIG. 2 is a plot of voltage versus capacity for an anode that contains the alloy composition Si₅₂Cu₃₉Ag₉.

FIG. 3 is a plot of differential capacity versus voltage for an anode that contains the alloy composition Si₅₂Cu₃₉Ag₉.

FIG. 4 is a plot of intensity versus scattering angle of the powder x-ray diffraction pattern of an alloy composition Si₄₉Cu₄₂Ag₇Sn₂.

FIG. 5 is a plot of voltage versus capacity for an anode that contains the alloy composition Si₄₉Cu₄₂Ag₇Sn₂.

FIG. 6 is a plot of differential capacity versus voltage for an anode that contains the alloy composition Si₄₉Cu₄₂Ag₇Sn₂.

FIG. 7 is a plot of intensity versus scattering angle of the powder x-ray diffraction pattern of an alloy composition Si₇₀Ag₃₀.

FIG. 8 is a plot of voltage versus capacity for an anode that contains the alloy composition Si₇₀Ag₃₀. FIG. 9 is a plot of differential capacity versus voltage for an anode that contains the alloy composition Si₇₀Ag₃₀.

FIG. 10 is a plot of voltage versus capacity for an anode that contains only silicon as the electrochemically active metal.

FIG. 11 is a plot of differential capacity versus voltage for an anode that contains only silicon as the electrochemically active metal.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Anodes for lithium ion batteries are known that contain silicon or a silicon-containing alloy as the electrochemically active material. The formation of crystalline Li₁₅Si₄ during lithiation may adversely affect the cycle life of some of these anodes. The crystalline Li₁₅Si₄ often forms at potentials less than 50 mV versus a Li/Li⁺ reference electrode during lithiation. The formation of this crystalline material can be prevented or minimized, for example, by maintaining the anode at a potential equal to or greater than 50 mV versus a Li/Li⁺ reference electrode. However, to increase the total voltage of the battery, it is desirable to decrease the voltage of the anode below 50 mV vs. Li/Li⁺ reference electrode during lithiation. The total voltage of the battery is equal to the voltage of the cathode minus the voltage of the anode.

The present invention provides silicon-containing anodes with a composition that suppresses the formation of crystalline Li₁₅Si₄. The potential of the anode typically can be below 50 mV vs. Li/Li⁺ reference electrode during lithiation without adversely affecting the cycle life of the anode.

### DEFINITIONS

As used herein, the terms “a”, “an”, and “the” are used interchangeably with “at least one” to mean one or more of the elements being described.

As used herein, the term “electrochemically active” refers to a material that reacts with lithium under conditions typically encountered during charging and discharging of a lithium ion battery. The electrochemically active material is usually in the form of a metal or alloy.

As used herein, the term “electrochemically inactive” refers to a material that does not react with lithium under conditions typically encountered during charging and discharging of a lithium ion battery. The electrochemically inactive material is usually in the form of a metal or alloy.

As used herein, the term “metal” refers to both metals and metalloids such as silicon and germanium. The metal is often in an elemental state.

As used herein, the term “lithiation” refers to the process of adding lithium to the alloy composition (i.e., lithium ions are reduced).

As used herein, the term “delithiation” refers to the process of removing lithium from the alloy composition (i.e., lithium ions are oxidized).

As used herein, the term “charging” refers to a process of providing electrochemical energy to a battery.

As used herein, the term “discharging” refers to a process of removing electrochemical energy from a battery (i.e., discharging is a process of using the battery to do useful work).

As used herein, the term “silver alloy” refers to a combination of silver and at least one other electrochemically active metal such as, for example, tin, gallium, indium, zinc, lead, germanium, bismuth, aluminum, cadmium, or a combination thereof.

As used herein, the term “matrix” refers to an electrochemically inactive material that may be present in an alloy composition. The matrix is formed by reacting silicon with a matrix former, aluminum with a matrix former, or silicon and aluminum with a matrix former.

As used herein, the term “matrix former” refers to a metal that reacts with silicon, aluminum, or a combination thereof to form an electrochemically inactive matrix. Suitable matrix formers include, but are not limited to, transition metals, rare earth metals, or a combination thereof.

As used herein, the term “cathode” refers to the electrode where electrochemical reduction occurs during the discharging process. During discharging, the cathode undergoes lithiation. During charging, lithium atoms are removed from this electrode.

As used herein, the term “anode” refers to the electrode where electrochemical oxidation occurs during the discharging process. During discharging, the anode undergoes delithiation. During charging, lithium atoms are added to this electrode.

Lithium Ion Battery

In one aspect, lithium ion batteries are provided that includes a cathode, an anode, and an electrolyte that separates the cathode from the anode. The anode, which includes an alloy composition, can be subjected to repetitive cycles of lithiation and delithiation. The alloy composition contains (i) silicon in an amount of at least 10 mole percent; (ii) copper in an amount of at least 3 mole percent; and (iii) silver or a silver alloy in an amount of 1 to 50 mole percent.

At least some of the silicon included in the alloy composition is present as an electrochemically active metal. That is, at least some of the silicon in the alloy composition can react with lithium. In some alloy compositions, all of the silicon is present as an electrochemically active metal. In other alloy compositions, part of the silicon is present as an electrochemically active metal and part of the silicon is present as an electrochemically inactive metal. The electrochemically inactive silicon functions as a matrix or part of a matrix (e.g., silicon can be combined with a matrix former to provide a matrix) and does not undergo lithiation or delithiation during charging or discharging of the lithium ion battery.

The alloy composition includes at least 10 mole percent, at least 20 mole percent, at least 30 mole percent, at least 35 mole percent, or at least 40 mole percent silicon. The alloy compositions can include up to 90 mole percent, up to 85 mole percent, up to 80 mole percent, up to 70 mole percent, or up to 60 mole percent silicon. For example, the silicon content can be 10 to 90 mole percent, 20 to 85 mole percent, 30 to 80 mole percent, 35 to 70 mole percent, or 40 to 60 mole percent based on moles of the alloy composition.

The alloy composition includes at least 3 mole percent copper. Some alloy compositions include at least 10 mole percent, at least 20 mole percent, at least 30 mole percent, or at least 40 mole percent copper. If lower amounts of copper are used, it can be difficult to adequately suppress the formation of crystalline Li₁₅Si₄ during lithiation at potentials less than 50 mV versus a Li/Li⁺ reference electrode. That is, copper in combination with silver or a silver alloy can suppress the formation of crystalline Li₁₅Si₄ during lithiation at potentials less than 50 mV versus a Li/Li⁺ reference electrode. Exemplary alloy compositions include 3 to 60 mole percent, 10 to 60 mole percent, 20 to 60 mole percent, or 30 to 60 mole percent copper.

The copper is often present in the form of a copper silicide (e.g., Cu₃Si). Silicon in the form of copper silicide tends to be electrochemically active. If aluminum is present as a matrix former, higher levels of copper can be used to ensure the formation of copper silicide. That is, copper tends to be more reactive with aluminum than silicon; to ensure that there is some copper silicide present, higher levels of copper can be used in the presence of aluminum (e.g., aluminum and copper can combine to form an alloy that is electrochemically inactive).

The combination of copper with silver or a silver alloy tends to suppress the formation of crystalline Li₁₅Si₄ during lithiation at potentials less than 50 mV versus a Li/Li⁺ reference electrode. That is, silver or the silver alloy enhances the suppression of the crystalline Li₁₅Si₄ over the suppression caused by copper alone. Suitable silver alloys include silver combined with at least one electrochemically active metal such as, for example, tin, gallium, indium, zinc, lead, germanium, bismuth, aluminum, cadmium, or a combination thereof. In some exemplary alloy compositions, the silver alloy is a mixture of silver and tin (e.g., Ag₄Sn) or silver and zinc.

The alloy composition includes at least 1 mole percent, at least 2 mole percent, at least 3 mole percent, at least 5 mole percent, at least 10 mole percent, or at least 20 mole percent silver or silver alloy. The alloy composition can include up to 50 mole percent, up to 40 mole percent, up to 30 mole percent, or up to 20 mole percent silver or silver alloy. For example, the alloy composition can include 1 to 50 mole percent, 2 to 50 mole percent, 2 to 40 mole percent, 2 to 30 mole percent, or 2 to 20 mole percent silver or silver alloy. Some silver alloys contain at lest 50 mole percent, at least 60 mole percent, at least 70 mole percent, at least 80 mole percent, or at least 90 mole percent silver.

Some alloy compositions further comprise aluminum. The aluminum can be an electrochemically active material, an electrochemically inactive material, or a combination thereof. If aluminum is alloyed with silver, the aluminum is in an electrochemically active form. However, if the aluminum is alloyed with a matrix former, or a combination of silicon and a matrix former, the aluminum is present in an electrochemically inactive form. The alloy composition can include up to 60 atomic percent, up to 50 atomic percent, up to 40 atomic percent, up to 30 atomic percent, up to 20 atomic percent, up to 10 atomic percent, or up to 5 atomic percent aluminum.

The alloy composition can also include matrix formers. The matrix formers can combine with some of the silicon or aluminum that may be present to provide a matrix that is electrochemically inactive. The resulting matrix includes metal silicides, metal aluminides, ternary metal-silicon-aluminum alloys, or a combination thereof. The addition of the matrix former can decrease the volume change encountered when the alloy composition undergoes lithiation and delithiation. Exemplary matrix formers include, for example, transition metals, rare earth metal, or combinations thereof. Suitable matrix formers include, but are not limited to, nickel, cobalt, iron, manganese, titanium, chromium, molybdenum, niobium, tungsten, tantalum, lanthanum, cerium, Misch metal (i.e., a mixture of rare earth metals), or a combination thereof. Some alloy compositions include up to 86 mole percent, up to 80 mole percent, up to 60 mole percent, up to 40 mole percent, up to 20 mole percent, up to 10 mole percent, or up to 5 mole percent matrix former.

One exemplary alloy composition includes silicon in an amount of at least 35 mole percent, copper in an amount of 10 to 60 mole percent, and silver in an amount of 1 to 50 mole percent based on the moles of the alloy composition. Another exemplary alloy composition includes silicon in an amount 40 to 60 mole percent, copper in an amount of 20 to 60 mole percent, and silver in an amount of 2 to 20 mole percent based on moles of the alloy composition. Such an alloy composition, prior to a first lithiation, can contain the following phases: Si, Cu₃Si, and Ag with each phase having a grain size less than 500 Angstroms, less than 400 Angstroms, less than 300 Angstroms, less than 250 Angstroms, less than 200 Angstroms, or less than 150 Angstroms. A smaller grain size tends to favor diffusion of copper and the silver or silver alloy into the silicon and tends to facilitate suppression of crystalline Li₁₅Si₄ formation.

Yet another exemplary alloy composition includes silicon in an amount 40 to 60 mole percent, copper in an amount of 20 to 60 mole percent, and a silver or a silver alloy in an amount of 2 to 30 mole percent based on the moles of the alloy composition, where the silver or a silver alloy includes silver and at least one element selected from tin, gallium, indium, zinc, lead, germanium, bismuth, aluminum, or cadmium. Such an alloy composition, prior to a first lithiation, can contain the following phases: Si, Cu₃Si, and Ag₍₁₋ₓ₎Zₓ where Z is selected from tin, gallium, indium, zinc, lead, germanium, bismuth, aluminum, cadmium, or a combination thereof; and x equals 0 to about 0.95. Each phase has a grain size less than 500 Angstroms, less than 400 Angstroms, less than 300 Angstroms, less than 250 Angstroms, less than 200 Angstroms, or less than 150 Angstroms. In a more specific example, where the silver or a silver alloy includes silver and tin, the alloy composition can include Si, Cu₃Si, and Ag₄Sn prior to a first lithiation.

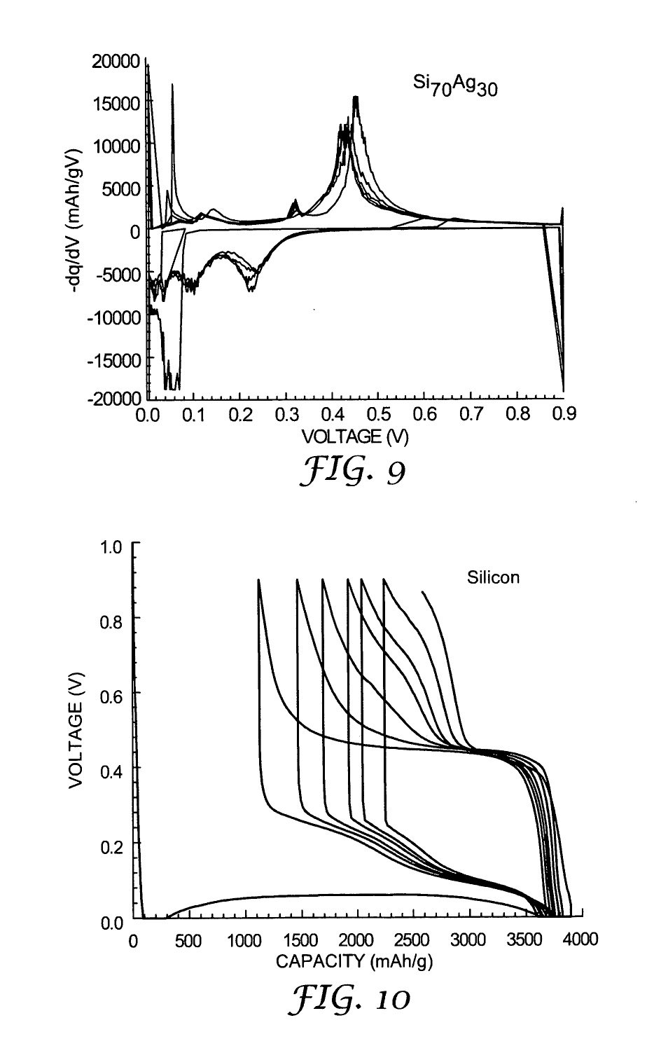

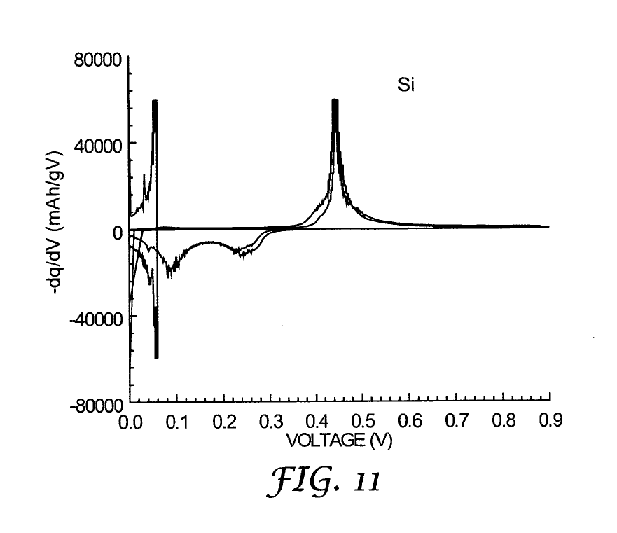

In a prior art anode prepared from silicon without copper or silver, crystalline Li₁₅Si₄ forms during lithiation at potentials less than 50 mV versus a Li/Li³⁰ reference electrode. When such an anode is then subjected to delithiation, a plot of the differential capacity (−dq/dV with units of mAh/gV) as a function of voltage has a peak at about 0.45 volts versus a Li/Li⁺ reference electrode. Such a plot is in FIG. 11 with the plot of voltage versus capacity in FIG. 10. There are no other peaks in the differential capacity plot during delithiation. That is, 100 percent of the area under the differential capacity curve recorded during delithiation results from a removal of lithium from crystalline Li₁₅Si₄.

In these prior art anodes, a two-phase region tends to form during delithiation. That is, some regions of the particle contain a silicon phase and other regions of the particle contain a crystalline Li₁₅Si₄ phase. The presence of these two phases can cause internal stress within the particle and can contribute to the poor cycling performance of silicon electrodes.

In contrast, for anodes prepared from the alloy compositions described herein that contain silicon, copper, and a silver or a silver alloy, no more than 15 percent of the area under the differential capacity versus voltage curve recorded during delithiation results from (i.e., is caused by or is attributable to) the removal of lithium from Li₁₅Si₄. That is, these alloy combinations suppress the formation of crystalline Li₁₅Si₄ during lithiation at potentials less than 50 mV versus a Li/Li⁺ reference. Subsequently, the capacity attributable to removal of lithium from crystalline Li₁₅Si₄ during delithiation is decreased. For some anodes, the peak attributable to removal of lithium from crystalline Li₁₅Si₄ accounts for no more than 10 percent, no more than 8 percent, no more than 6 percent, no more than 5 percent, no more than 4 percent, no more than 3 percent, or no more than 2 percent of the area under the differential capacity curve during delithiation.

A plot of differential capacity versus voltage for an alloy composition that contains silicon, copper, and silver is in FIG. 3. During the initial lithiation, a relatively large peak is evident at potentials less than 50 mV versus a Li/Li⁺ reference electrode that results from the lithiation of crystalline silicon and the formation of crystalline Li₁₅Si₄. The subsequent first delithiation includes a peak at about 0.08 V versus a Li/Li⁺ reference electrode and another peak at about 0.46 V versus a Li/Li⁺ reference electrode. After repetitive cycles of lithiation and delithiation, both of these delithiation peaks are absent or smaller.

The peak at 0.08 V versus a Li/Li⁺ reference electrode during the first delithiation results from the removal of lithium from a crystalline lithium-silver alloy. This peak is absent or smaller in subsequent cycles of lithiation and delithiation, indicating that silver may no longer be present as a separate crystalline phase but may be present in the form of an amorphous material such as, for example, a ternary phase material that includes copper, silicon, and silver.

The peak at 0.46 V versus a Li/Li⁺ reference electrode during the first delithiation results from the removal of lithium from crystalline Li₁₅Si₄. This peak is absent or smaller in subsequent cycles of lithiation and delithiation, indicating that the formation of crystalline Li₁₅Si₄ is suppressed after one cycle. Although not wanting to be bound be theory, it is believed that the incorporation of copper and silver into the silicon-containing alloy results in the inability of the silicon and lithium atoms to reorganize into the crystalline Li₁₅Si₄ phase during lithiation. Consequently, an amorphous state is maintained during cycling and the formation of crystalline Li₁₅Si₄ is suppressed in subsequent cycles of lithiation and delithiation. The formation of the amorphous state is believed to contribute to less internal stress within the alloy composition.

The alloy compositions of the anode can be in the form of a thin film or powders, the form depending on the technique chosen to prepare the materials. Suitable methods of preparing the alloy compositions include, but are not limited to, sputtering, chemical vapor deposition, vacuum evaporation, melt spinning, splat cooling, spray atomization, electrochemical deposition, and ball milling. Suitable procedures are described in greater detail in U.S. Pat. No. 6,669,336 B2 (Turner et al.), U.S. Pat. No. 6,255,017 B1 (Turner), U.S. Pat. No. 6,428,933 B1 (Christensen et al.), and U.S. Pat. No. 6,203,944 B1 (Turner et al.); and U.S. Patent Application Publication 2004/0058240 A1 (Christensen), the disclosures of which are all incorporated herein by reference.

In some embodiments, the alloy compositions are in the form of powders that are prepared using a melt spinning process. Such processes are described generally, for example, in Amorphous Metallic Alloys, F. E. Luborsky, ed., Chapter 2, Butterworth & Co., Ltd., 1983. According to this process, ingots containing the alloy composition can be melted in a radio frequency field and then ejected through a nozzle onto a surface of a rotating wheel (e.g., a copper wheel). Because the surface temperature of the rotating wheel is substantially lower than the temperature of the melt, contact with the surface of the rotating wheel quenches the melt. Quenching minimizes the formation of large crystallites that can be detrimental to electrode performance.

Suitable powders can include silicon, copper, silver or a silver alloy, and any optional matrix former within a particle. Each phase originally present in the particle (i.e., before a first lithiation) is usually in contact with the other phases in the particle. For example, the silicon phase can be in contact with both a copper silicide phase and a silver or silver alloy phase. Each phase has a grain size that is less than 500 Angstroms, less than 400 Angstroms, less than 300 Angstroms, less than 200 Angstroms, or less than 150 Angstroms.

Some alloy compositions are in the form of a particle that includes a conductive coating. For example, a particle that contains silicon, copper, and silver or a silver alloy can be coated with a layer of conducting material (e.g., the alloy composition is in the core of the particle and the shell of the particle includes a conductive material). Suitable conductive materials include, but are not limited to, carbon, copper, silver, or nickel. The conductive materials can be formed using techniques such as electroplating, chemical vapor deposition, vacuum evaporation and sputtering.

Exemplary powders have a maximum dimension that is no greater than 60 micrometers, no greater than 40 micrometers, or no greater than 20 micrometers. The powders often have a maximum dimension of at least 1 micrometer, at least 2 micrometers, at least 5 micrometers, or at least 10 micrometers. For example, suitable powders often have a maximum dimension of 1 to 60 micrometers, 10 to 60 micrometers, 20 to 60 micrometers, 40 to 60 micrometers, 1 to 40 micrometers, 2 to 40 micrometers, 10 to 40 micrometers, 5 to 20 micrometers, or 10 to 20 micrometers.

In some embodiments, the anode contains the alloy composition dispersed in an elastomeric polymer binder. Exemplary elastomeric polymer binders include polyolefins such as those prepared from ethylene, propylene, or butylene monomers; fluorinated polyolefins such as those prepared from vinylidene fluoride monomers; perfluorinated polyolefins such as those prepared from hexafluoropropylene monomer; perfluorinated poly(alkyl vinyl ethers); perfluorinated poly(alkoxy vinyl ethers); or combinations thereof. Specific examples of elastomeric polymer binders include terpolymers of vinylidene fluoride, tetrafluoroethylene, and propylene; and copolymers of vinylidene fluoride and hexafluoropropylene. Commercially available fluorinated elastomers include those sold by Dyneon, LLC, Oakdale, Minn. under the trade designation “FC-2178”, “FC-2179”, and “BRE-731X”.

In some anodes, the elastomeric binders are crosslinked. Crosslinking can improve the mechanical properties of the polymer and can improve the contact between the alloy composition and any electrically conductive diluent that may be present.

An electrically conductive diluent can be added to facilitate electron transfer from the alloy composition to a current collector. Exemplary electrically conductive diluents include, but are not limited to, carbon, metal, metal nitrides, metal carbides, metal silicides, and metal borides. In some anodes, the electrically conductive diluents are carbon blacks such as those commercially available from MMM Carbon of Belgium under the trade designation “SUPER P” and “SUPER S” and from Chevron Chemical Co. of Houston, Tex. under the trade designation “SHAWANIGAN BLACK”; acetylene black; furnace black; lamp black; graphite; carbon fibers; or combinations thereof.

The anode can further include an adhesion promoter that promotes adhesion of the alloy composition and the electrically conductive diluent to the elastomeric polymer binder. The combination of an adhesion promoter and elastomeric polymer binder accommodates, at least partially, volume changes that may occur in the alloy composition during repeated cycles of lithiation and delithiation. The adhesion promoter can be part of the binder (e.g., in the form of a functional group) or can be in the form a coating on the alloy composition, the electrically conductive diluent, or a combination thereof. Examples of adhesion promoters include, but are not limited to, silanes, titanates, and phosphonates as described in U.S. Patent Application 2003/0058240, the disclosure of which is incorporated herein by reference.

Any suitable electrolyte can be included in the lithium ion battery. The electrolyte can be in the form of a solid or liquid. Exemplary solid electrolytes include polymeric electrolytes such as polyethylene oxide, polytetrafluoroethylene, polyvinylidene fluoride, fluorine-containing copolymers, polyacrylonitrile, or combinations thereof. Exemplary liquid electrolytes include ethylene carbonate, dimethyl carbonate, diethyl carbonate, propylene carbonate, gamma-butyrolactone, tetrahydrofuran, 1,2-dimethoxyethane, dioxolane, or combinations thereof. The electrolyte includes a lithium electrolyte salt such as LiPF₆, LiBF₄, LiClO₄, LiN(SO₂CF₃)₂, LiN(SO₂CF₂CF₃)₂, and the like.

The electrolyte can include a redox shuttle molecule, an electrochemically reversible material that during charging can become oxidized at the cathode, migrate to the anode where it can become reduced to reform the unoxidized (or less-oxidized) shuttle species, and migrate back to the cathode. Suitable redox shuttle molecules include, for example, those described in U.S. Pat. Nos. 5,709,968 (Shimizu), U.S. Pat. No. 5,763,119 (Adachi), U.S. Pat. No. 5,536,599 (Alamgir et al.), U.S. Pat. No. 5,858,573 (Abraham et al.), U.S. Pat. No. 5,882,812 (Visco et al.), U.S. Pat. No. 6,004,698 (Richardson et al.), U.S. Pat. No. 6,045,952 (Kerr et al.), and U.S. Pat. No. 6,387,571 B1 (Lain et al.); and in PCT Published Patent Application No. WO 01/29920 A1 (Richardson et al.).

Any suitable cathode known for use in lithium ion batteries can be utilized. Some exemplary cathodes in a charged state contain lithium atoms intercalated within a lithium transition metal oxide such as lithium cobalt dioxide, lithium nickel dioxide, and lithium manganese dioxide. Other exemplary cathodes are those disclosed in U.S. Pat. No. 6,680,145 B2 (Obrovac et al.), incorporated herein by reference. That is, the cathode can contain particles that include transition metal grains (e.g., iron, cobalt, chromium, nickel, vanadium, manganese, copper, zinc, zirconium, molybdenum, niobium, or combinations thereof) having a grain size no greater than about 50 nanometers in combination with lithium-containing grains selected from lithium oxides, lithium sulfides, lithium halides (e.g., chlorides, bromides, iodides, or fluorides), or combinations thereof. These particles can be used alone or in combination with a lithium-transition metal oxide material such as lithium cobalt dioxide.

In some lithium ion batteries with solid electrolytes, the cathode can include LiV₃O₈ or LiV₂O₅. In other lithium ion batteries with liquid electrolytes, the cathode can include LiCoO₂, LiCo_{0.2}Ni_{0.8}O₂, LiMn₂O₄, LiFePO₄, or LiNiO₂.

The lithium ion batteries can be used as a power supply in a variety of applications. For example, the lithium ion batteries can be used in power supplies for electronic devices such as computers and various hand-held devices, motor vehicles, power tools, photographic equipment, and telecommunication devices. Multiple lithium ion batteries can be combined to provide a battery pack.

Methods of Making Lithium Ion Battery

Another aspect of the invention features a method of preparing a lithium ion battery. The method includes providing a cathode, an anode, and an electrolyte that separates the cathode from the anode; and subjecting the anode to repetitive cycles of lithiation and delithiation to a potential less than 50 millivolts versus a Li/Li⁺ reference electrode during lithiation. The anode contains an alloy composition that includes silicon in an amount of at least 10 mole percent, copper in an amount of at least 3 mole percent, and silver or a silver alloy in an amount of 1 to 50 mole percent based on moles of the alloy composition. After 5 such repetitive cycles of lithiation and delithiation, no more than 15 percent of an area under a differential capacity versus voltage curve for the anode measured during delithiation results from a removal of lithium from a crystalline Li₁₅Si₄ phase.

In some methods, the potential during lithiation can be less than 40 mV, less than 30 mV, less than 20 mV, or less than 10 mV versus a Li/Li⁺ reference electrode. The upper potential limit is typically 0.8 V, 0.9 V, 1.0 V, 1.5 V, or 2.0 V versus a Li/Li⁺ reference electrode.

The repetitive cycles of lithiation and delithiation usually occur at a temperature in the range of −20° C. to 40° C., 0° C. to 40° C., 10° C. to 40° C., 20° C. to 40° C., or 20° C. to 30° C. In some examples, the battery is cycled at a pretreatment temperature in excess of 40° C. prior to cycling at temperatures in the range of −20 C. to 40 C. Suitable pretreatment temperatures include temperatures in the range of 40° C. to 80° C., 50° C. to 80° C., or 50° C. to 70° C.

After 5 repetitive cycles of lithiation and delithiation, no more than 15 percent of an area under a differential capacity versus voltage curve for the anode measured during delithiation results from removal of lithium from a crystalline Li₁₅Si₄ phase. In some examples, this level of suppression is achieved after 4 cycles, after 3 cycles, after 2 cycles, or after 1 cycle of lithiation and delithiation.

The differential capacities versus voltage plots have a broad peak centered around about 0.3 V versus a Li/Li⁺ reference electrode during delithiation after at a few repetitive cycles of lithiation and delithiation. The appearance of this broad peak combined with the disappearance of the narrow peak at about 0.4 V to 0.5 V versus a Li/Li⁺ reference electrode indicates that amorphous rather than crystalline materials are involved in the lithiation and delithiation reactions.

The invention can be further described by way of the following examples.

### EXAMPLES

Method of Measuring Area Under Differential Capacity Curve

The area under the Li₁₅Si₄ peak was measured by fitting the differential capacity curve during delithiation with three Gaussian functions. A Gaussian function at 0.3 V versus a Li/Li⁺ reference electrode with a fixed half-width of 0.115 V and variable amplitude was used to fit the broad feature observed in the differential capacity curves at about 0.3 V versus a Li/Li⁺ reference electrode. A Guassian function at 0.558 V versus a Li/Li⁺ reference electrode with a fixed half-width of 0.117 V and variable amplitude was used to fit the broad feature in the differential capacity curves at about 0.558 V versus a Li/Li⁺ reference electrode. A Gaussian function with variable position, half-width and amplitude was then used to fit the remaining Li₁₅Si₄ peak near 0.4 V versus a Li/Li⁺ reference electrode. The percent area of the differential capacity curve attributed to the delithiation of Li₁₅Si₄ was then taken as the percent area of the Gaussian function fit to the Li₁₅Si₄ peak near 0.4 V versus a Li/Li⁺ reference electrode with respect to the total area of the three peaks used to fit the differential capacity curve during delithiation.

### Example 1

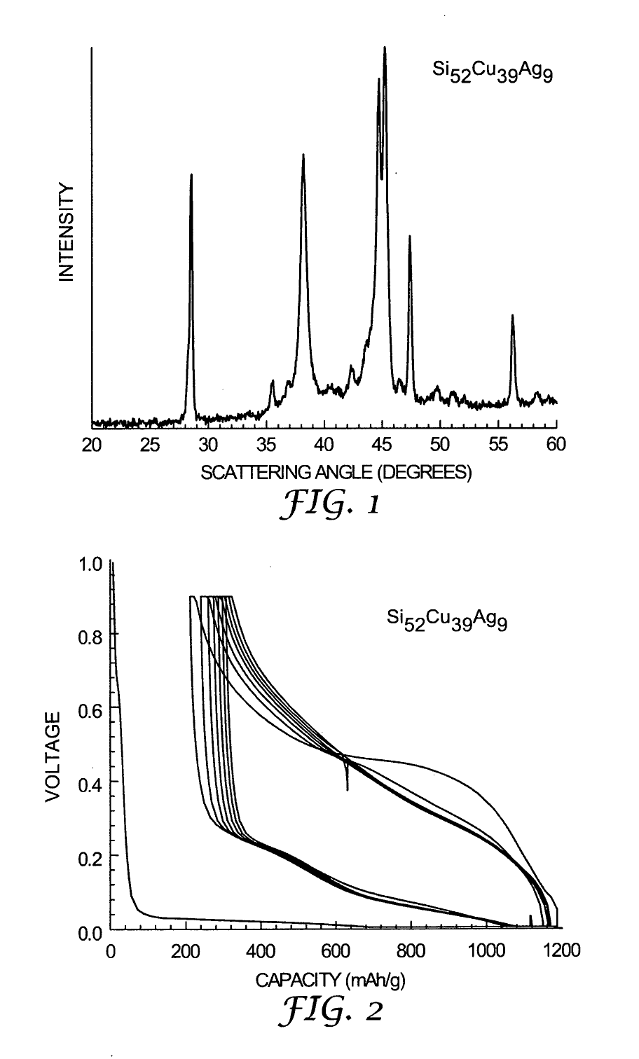

1.828 g of silicon chips (Alfa Aesar, Ward Hill, Mass.) and 12.407 g of copper shot (Alfa Aesar, Ward Hill, Mass.) (all 99.9 wt % purity or better) were melted together on a carbon hearth in an argon filled arc furnace purchased from Advanced Vacuum Systems, Ayer, Mass. The resulting ingot was melted with 4.860 g of silver shot (Alfa Aesar, Ward Hill, Mass.) and 5.484 g of silicon chips (99.9 wt % purity or better) in an argon-filled arc furnace with a copper hearth. The final resulting ingot had a composition of Si₅₂Cu₃₉Ag₉ and was broken into 1 cm pieces. 15 g of the pieces were placed in a quartz tube with a 0.762 mm diameter orifice. The tube was placed in a melt-spinning chamber and melt-spun from a 1250° C. melt in a 200 Torr helium atmosphere with a 200 Torr helium overpressure onto a 20.32 cm diameter copper wheel spinning at 3290 rpm. The resulting ribbon shards were pulverized by ball milling and subsequently classified by sieving to give a particle size between 32 μm and 53 μm. FIG. 1 shows the x-ray diffraction (XRD) pattern of the prepared sample taken on a Siemens D500 Diffractometer equipped with a Cu-target and a diffracted beam monochromator. From the XRD pattern it was determined that the ribbon contains Si, Ag and Cu₃Si phases and that the grain size of the Ag phase is 150 Angstroms. The grain size was determined using the Scherrer equation.

To prepare electrodes for electrochemical cycling, 0.8 g of the Si₅₂Cu₃₉Ag₉ powder was mixed with 1 g of N-methyl-2-pyrrolidinone (NMP). Next, 4.16 g of a 6 wt % solids suspension of SUPER P carbon (available from MMM Carbon, Belgium) in NMP and polyvinylidene fluoride (KYNAR 461, available from Elf Atochem, Philadelphia, Pa.), 1:1 by weight, was added to the powder/NMP mixture. The resulting mixture was stirred at high shear for 5 minutes, and then coated onto a 0.305 mm copper foil (All Foils, Inc., Cleveland, Ohio) with a notch bar to provide an 76.2 wt % alloy composition, 11.9 wt % polyvinylidene fluoride, and 11.9 wt % SUPER P carbon coating. The coating was dried in a vacuum at 15020 C. for 12 hours to form the electrode. The electrode was then used to construct 2325 coin cells with a 300 micrometer thick metallic lithium foil counter/reference electrode, two layers of a flat sheet polethylene membrane separator (CELGARD 2400, available from CELGARD Inc., Charlotte, N.C.), and 1 M LiPF₆ in a 1:2 mixture of ethylene carbonate and diethyl carbonate as the electrolyte. The 2325 coin cell hardware is described in A. M. Wilson and J. R. Dahn, J. Electrochem. Soc., 142, 326-332 (1995).

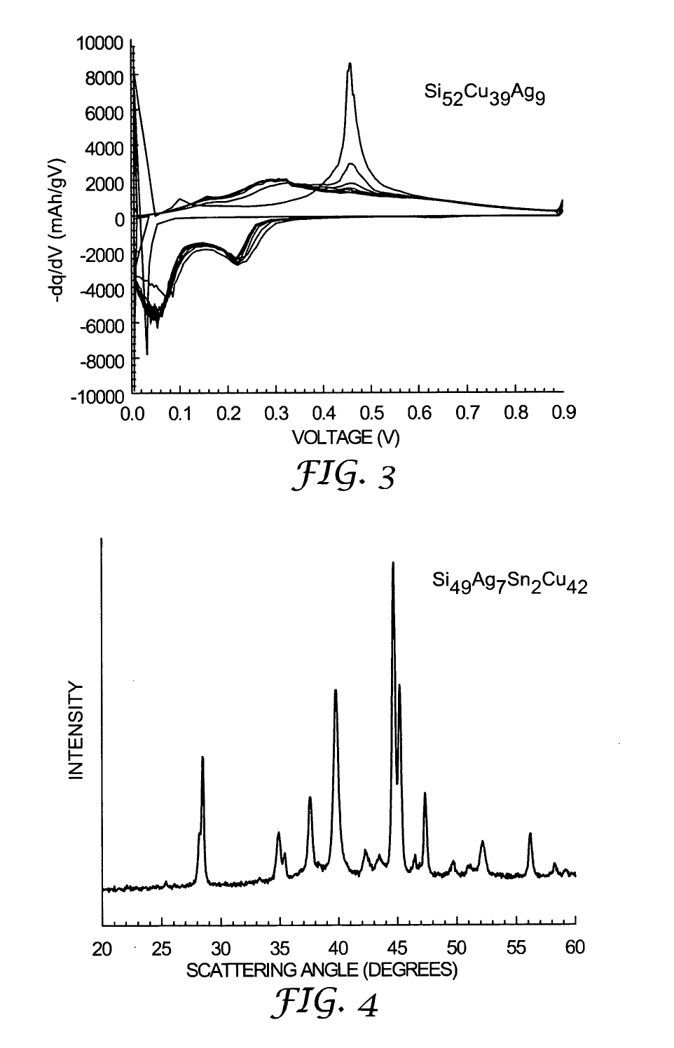

Electrochemical cells were cycled between 0.9 V vs. the metallic Li/Li⁺ reference electrode and 5 mV vs. Li metal Li/Li ion reference electrode at a constant current of 100 mA/g (500 μA) using a cell tester (Maccor Inc., Tulsa Okla.). The current was allowed to relax to 10 mA/g (50 μA) at the lower voltage cutoff before the next charge cycle. The voltage versus capacity curve is in FIG. 2 and the differential capacity curve versus voltage is in FIG. 3. A peak in the differential capacity curve of FIG. 3 during the first cycle at about 0.08 V vs. the metallic lithium Li/Li⁺ reference electrode was present. This peak was due to the delithiation of crystalline lithium-silver and is not present in subsequent cycles. A large sharp peak in the differential capacity curve at about 0.46 V vs. the metallic lithium Li/Li⁺ reference electrode was also present during the first cycle due to the delithiation of crystalline Li₁₅Si₄. After 5 charge/discharge cycles, about 1 percent of the total area under the differential capacity curve during delithiation was attributable to removal of lithium from crystalline Li₁₅Si₄.

### Example 2

20.87 g Cu shot and 3.08 g of silicon chips (all 99.9% purity or better) were melted together on a carbon hearth in an argon filled arc furnace. 18.235 g of the resulting ingot was melted with 4.497 g of silver shot, 1.414 g of tin shot (Aldrich Chemical Co., Milwaukee, Wis.) and 5.845 g of silicon chips (99.9% purity or better) in an argon filled arc furnace on a water-cooled copper hearth. The resulting ingot had a composition of Si₄₉Cu₄₂Ag₇Sn₂ and was broken into 1 cm pieces. 15 g of the pieces were placed in a quartz tube with a 0.038 mm diameter orifice. The tube was placed in a melt-spinning chamber and melt-spun from a 1300° C. melt in a 200 Torr helium atmosphere with a 200 Torr overpressure onto an 20.32 mm diameter copper wheel spinning at 5000 rpm. The resulting ribbon shards where pulverized and subsequently classified by sieving to give a particle size between 32 μm and 53 μm. FIG. 4 shows the XRD pattern of the prepared sample. From the XRD pattern it was determined that the ribbon is composed of Si, Cu₃Si and Ag₄Sn phases and that the grain size of the Ag₄Sn phase is 260 Angstroms.

To prepare electrodes for electrochemical cycling, 0.8 g of the Si₄₉Cu₄₂Ag₇Sn₂ powder was mixed with 1 g of N-methyl-2-pyrrolidinone (NMP). Next, 4.16 g of a 6 wt % solids suspension of SUPER P carbon (available from MMM Carbon, Belgium) in NMP and polyvinylidene fluoride (KYNAR 461, available from Elf Atochem), 1:1 by weight, were added to the powder/NMP mixture. The resulting mixture was stirred at high shear for 5 minutes, and then coated onto a 0.305 mm copper foil with a notch bar to provide an 76.2 wt % alloy composition, 11.9 wt % polyvinylidene fluoride, 11.9 wt % SUPER P carbon coating. The coating was dried in a vacuum at 150° C. for 12 hours to form the electrode. The electrode was then used to construct 2325 coin cells with a metallic lithium counter/reference electrode, two layers of CELGARD 2400 as the separator, and 1 M LiPF₆ in a 1:2 mixture of ethylene carbonate and diethyl carbonate as the electrolyte.

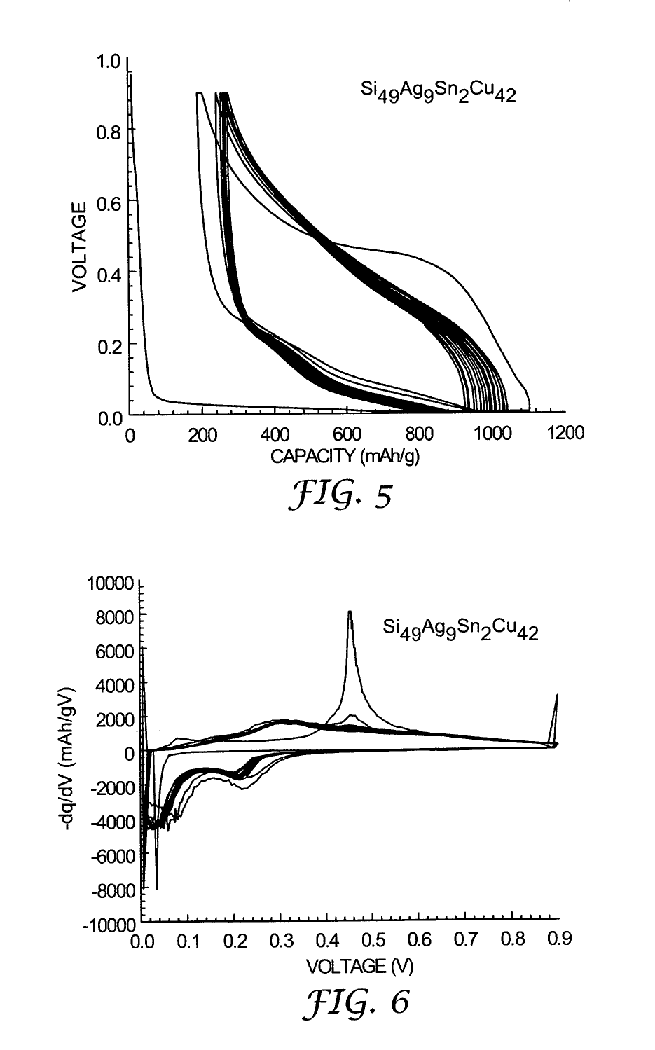

Electrochemical cells were cycled using a battery cell tester (Maacor) between 0.9 V vs. the metallic Li/Li⁺ reference electrode and 5 mV vs. the metallic Li/Li⁺ reference electrode at a constant current of 68 mA/g (500 μA). The current was allowed to relax to 14 mA/g (100 μA) at the lower voltage cutoff before the next charge cycle. The voltage versus capacity curve is in FIG. 5 and the differential capacity versus voltage curve is in FIG. 6. Peaks in the differential capacity curve at about 0.08 V and 0.46 V vs. the metallic Li/Li⁺ reference electrode were present in the first cycle during delithiation. These peaks were due to the delithiation of crystalline lithium-silver and Li₁₅Si₄ phases respectively. After 5 cycles, about 4 percent of the total area under the differential capacity curve during delithiation was attributable to removal of lithium from crystalline Li₁₅Si₄.

### Comparative Example 1

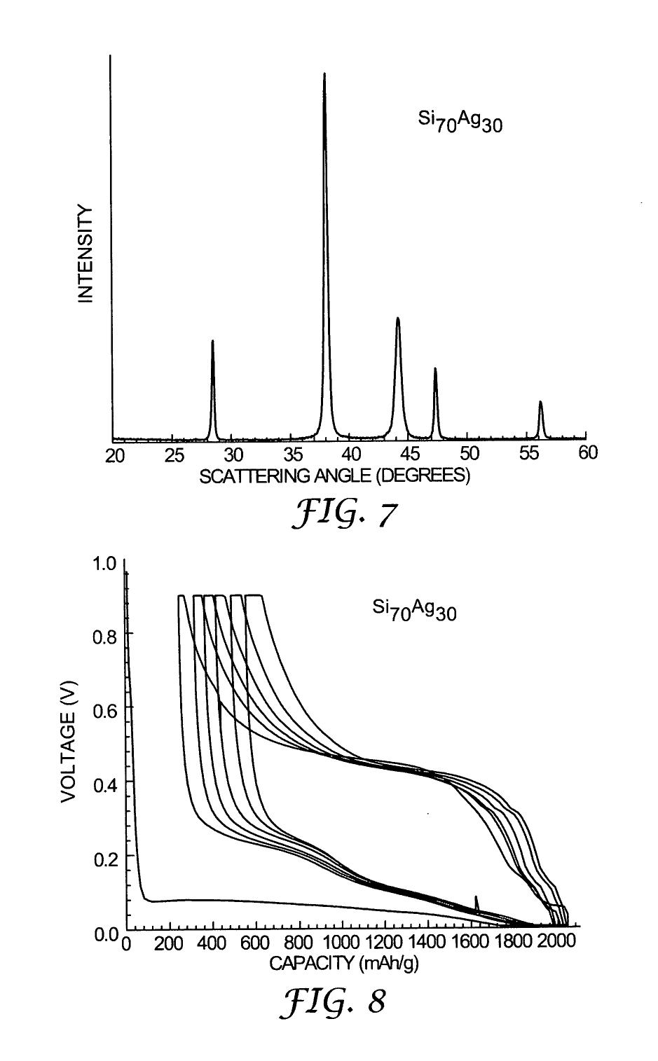

9.331 g of silver shot and 5.67 g of silicon chips (99.9% purity or better) were melted together in an argon filled arc furnace on a water-cooled copper hearth. The resulting ingot had a composition of Si₇₀Ag₃₀ and was broken into 1 cm pieces. 15 g of the pieces were placed in a graphite tube with a 0.038 mm diameter orifice. The tube was placed in a melt-spinning chamber and melt-spun from a 1450° C. melt in a 200 Torr helium atmosphere with a 200 Torr overpressure onto an 20.32 mm diameter copper wheel spinning at 3290 rpm. The resulting ribbon shards where pulverized and subsequently classified by to give a particle size between 32 μm and 53 μm. FIG. 7 shows the XRD pattern of the prepared sample. Based on the XRD pattern, the ribbon was composed of Si and Ag phases and the grain size of the Ag phase was 257 angstroms.

To prepare electrodes for electrochemical cycling, 0.8 g of the Si₇₀Ag₃₀ powder was mixed with 1 g of N-methyl-2-pyrrolidinone (NMP). Next, 4.16 g of a 6 wt % solids suspension of SUPER P carbon (available from MMM Carbon, Belgium) in NMP and polyvinylidene fluoride (KYNAR 461, available from Elf Atochem), 1:1 by weight, were added to the powder/NMP mixture. The resulting mixture was stirred at high shear for 5 minutes, and then coated onto a 0.305 mm copper foil with a notch bar to provide an 76.2 wt % alloy composition, 11.9 wt % polyvinylidene fluoride, and 11.9 wt % SUPER P carbon coating. The coating was dried in a vacuum at 150° C. for 12 hours to form the electrode. The electrode was then used to construct 2325 coin cells by combining it with a metallic lithium counter/reference electrode, two layers of CELGARD 2400 as the separator, and 1 M LiPF₆ in a 1:2 mixture of ethylene carbonate and diethyl carbonate as the electrolyte.

Electrochemical cells were cycled using a battery cell tester (Maacor) between 0.9 V vs. the metallic Li/Li⁺ reference electrode and 5 mV vs. the metallic Li/Li⁺ reference electrode at a constant current of 100 mA/g (500 μA). The current was allowed to relax to 10 mA/g (50 μA) at the lower voltage cutoff before the next cycle. The voltage versus capacity curve is in FIG. 8 and the differential capacity versus voltage curve is in FIG. 9. After 5 cycles of lithiation and delithiation, the area under the differential capacity curve during delithiation that results from removal of lithium from Li₁₅Si₄ is 100 percent.

What is claimed is:

1. A lithium ion battery comprising a cathode, an anode, and an electrolyte separating the anode and the cathode, wherein said anode comprises an alloy composition comprising
a) silicon in an amount of at least 10 mole percent based on moles of the alloy composition;
b) copper in an amount of at least 3 mole percent based on moles of the alloy composition; and
c) a silver or a silver alloy in an amount of 1 to 50 mole percent based on moles of the alloy composition,
wherein when said anode is subjected to repetitive cycles of lithiation and delithiation to a potential less than 50 millivolts versus a Li/Li⁺ reference electrode during lithiation, no more than 15 percent of an area under a curve of a differential capacity versus voltage for the anode measured during delithiation results from a removal of lithium from a crystalline Li₁₅Si₄ phase after 5 repetitive cycles of lithiation and delithiation.

2. The lithium ion battery of claim 1, wherein the alloy composition comprises silicon in an amount of at least 35 mole percent, copper in an amount of at least 10 mole percent to 60 mole percent, and silver in an amount of 1 to 50 mole percent.

3. The lithium ion battery of claim 1, wherein the alloy composition comprises silicon in an amount 40 to 60 mole percent, copper in an amount of 20 to 60 mole percent, and silver in an amount of 2 to 20 mole percent.

4. The lithium ion battery of claim 1, wherein the silver alloy comprises silver and at least one other active metal selected from tin, gallium, indium, zinc, lead, germanium, bismuth, aluminum, or cadmium.

5. The lithium ion battery of claim 1, wherein the silver alloy comprises silver and tin.

6. The lithium ion battery of claim 1, wherein the alloy further comprises a matrix former comprising a transition metal, a rare earth metal, or a combination thereof.

7. The lithium ion battery of claim 1, wherein the alloy composition further comprises aluminum.

8. The lithium ion battery of claim 1, wherein the alloy composition comprises multiple phases prior to lithiation and each phase has a grain size no greater than 500 Angstroms.

9. The lithium ion battery of claim 1, wherein the alloy composition comprises particles having a maximum dimension of 10 micrometers to 60 micrometers.

10. The lithium ion battery of claim 1, wherein the alloy composition further comprises a conductive layer coating comprising carbon, copper, nickel, silver, or a combination thereof.

11. The lithium ion battery of claim 1, wherein the alloy composition comprises silicon in an amount 40 to 60 mole percent, copper in an amount of 20 to 60 mole percent, and silver or a silver alloy in an amount of 2 to 30 mole percent based on moles of the alloy composition, said silver alloy comprising silver and at least one element selected from tin, gallium, indium, zinc, lead, germanium, bismuth, or aluminum, or cadmium.

12. A battery pack comprising at least one lithium ion battery according to claim 1.

13. A method of preparing a lithium ion battery, said method comprising:
providing a cathode and an anode separated by an electrolyte, said anode comprising an alloy composition comprising
i) silicon in an amount of at least 10 mole percent based on moles of the alloy composition;
ii) copper in an amount of at least 3 mole percent based on moles of the alloy composition; and
iii) a silver or a silver alloy in an amount of 1 to 50 mole percent based on moles of the alloy composition;
subjecting the anode to repetitive cycles of lithiation and delithiation to a potential less than 50 millivolts versus a Li/Li⁺ reference electrode during lithiation, wherein after 5 such repetitive cycles of lithiation and delithiation, no more than 15 percent of an area under a curve of a differential capacity versus voltage for the anode measured during delithiation results from a removal of lithium from a crystalline Li₁₅Si₄ phase.

14. The method of claim 13, wherein said subjecting the anode to repetitive cycles of lithiation and delithiation occurs at a temperature of −20° C. to 40° C.

15. The method of claim 13, wherein the alloy composition comprises silicon in an amount of at last 35 mole percent, copper in an amount of at least 10 mole percent to 60 mole percent, and silver in an amount of 1 to 50 mole percent based on moles of the alloy composition.

16. The method of claim 13, wherein the alloy composition comprises silicon in an amount 40 to 60 mole percent, copper in an amount of 20 to 60 mole percent, and silver or a silver alloy in an amount of 2 to 30 mole percent based on the moles of the alloy composition, said silver alloy comprising silver and at least one element selected from tin, gallium, indium, zinc, lead, germanium, bismuth, aluminum, or cadmium.

17. The method of claim 13, wherein the alloy composition comprises multiple phases prior to lithiation and each phase has a grain size no greater than 500 Angstroms.

18. The method of claim 13, wherein the alloy composition comprises particles having a maximum dimension of 10 micrometers to 60 micrometers.

19. The method of claim 13, wherein the alloy composition further comprises aluminum.

20. The method of claim 13, wherein the alloy composition further comprises a matrix former.
